(19) United States
(12) Patent Application Publication
(10) Pub. No.: US 2026/0364449 A1
(43) Pub. Date: Nov. 19, 2026

(54) CHESS PIECE REINFORCEMENT METHOD[

(71) Applicant: Tencent Technology (Shenzhen) Company Limited, Shenzhen (CN)

(72) Inventor: Ziqi WEI, Shenzhen (CN)

(73) Assignee: Tencent Technology (Shenzhen) Company Limited, Shenzhen (CN)

(21) Appl. No.: 19/732,542

(22) Filed: Jul. 6, 2026

Related U.S. Application Data
(63) Continuation of application No. PCT/CN2025/109765, filed on Jul. 22, 2025.

(30) Foreign Application Priority Data
Aug. 20, 2024 (CN) 202411149281.7

(51) Int. Cl. A63F 13/52; A63F 13/533; A63F 13/58; A63F 13/822

(52) U.S. Cl. CPC A63F 13/52; A63F 13/533; A63F 13/58; A63F 13/822

(57) ABSTRACT

In a chess piece reinforcement method for a turn-based chess game, a plurality of chess pieces and a reinforcement card are displayed on a first game turn. The reinforcement card is configured to reinforce at least one attribute of the chess pieces and is associated with a reinforcement count. An attribute of a first chess piece of the plurality of chess pieces is reinforced based on use of the reinforcement card with the first chess piece. A first count and a first reinforcement identifier are displayed. The first reinforcement identifier represents that the attribute of the first chess piece is in a reinforced state, and the first count represents a remaining count of the reinforcement count. Apparatus and non-transitory computer-readable storage medium counterparts are also contemplated.

### CROSS-REFERENCE TO RELATED APPLICATIONS

The present application is a continuation of International Application No. PCT/CN2025/109765, filed on Jul. 22, 2025, which claims priority to Chinese Patent Application No. 202411149281.7, filed on Aug. 20, 2024. The entire disclosures of the prior applications are hereby incorporated by reference.

### FIELD OF THE TECHNOLOGY

This disclosure relates to the field of computer technologies, including to a chess piece reinforcement method and apparatus for a turn-based chess game, a device, and a non-transitory storage medium.

### BACKGROUND OF THE DISCLOSURE

A turn-based chess game is an emerging chess game. Each round of the game may include a plurality of game turns, chess pieces with different attributes may be placed on a chessboard in each game turn, and the attributes of the chess pieces represent battle capabilities of the chess pieces. The attributes of the chess pieces may include basic attributes such as an attack attribute, a support attribute, and a healing attribute, and may further include functional attributes such as an economic gain and free refreshing. In a game playing process, a battle winning probability may be improved by reinforcing the attributes of the chess pieces.

### SUMMARY

Embodiments of this disclosure include a chess piece reinforcement method and apparatus for a turn-based chess game, a device, and a non-transitory storage medium, to improve flexibility and game strategy in a chess piece reinforcement process, thereby improving a man-machine interaction rate of the turn-based chess game. Examples of technical solutions are as follows.

Technical solutions of the embodiments of this disclosure may be implemented in the following manners.

An embodiment of this disclosure provides a chess piece reinforcement method for a turn-based chess game. In the chess piece reinforcement method, a plurality of chess pieces and a reinforcement card are displayed on a first game turn. The reinforcement card is configured to reinforce at least one attribute of the chess pieces and is associated with a reinforcement count. An attribute of a first chess piece of the plurality of chess pieces is reinforced based on use of the reinforcement card with the first chess piece. A first count and a first reinforcement identifier are displayed. The first reinforcement identifier represents that the attribute of the first chess piece is in a reinforced state, and the first count represents a remaining count of the reinforcement count.

An embodiment of this disclosure provides a chess piece reinforcement apparatus. The chess piece reinforcement apparatus includes processing circuitry configured to display a plurality of chess pieces and a reinforcement card on a first game turn, the reinforcement card is configured to reinforce at least one attribute of the chess pieces and is associated with a reinforcement count. The processing circuitry is configured to reinforce an attribute of a first chess piece of the plurality of chess pieces based on use of the reinforcement card with the first chess piece. The processing circuitry is configured to display a first count and a first reinforcement identifier, the first reinforcement identifier representing that the attribute of the first chess piece is in a reinforced state, and the first count representing a remaining count of the reinforcement count.

An embodiment of this disclosure provides a non-transitory computer-readable storage medium storing instructions which when executed by a processor cause the processor to perform the chess piece reinforcement method.

An embodiment of this disclosure provides a chess piece reinforcement method for a turn-based chess game, the method being performed by a computer device, and the method comprising: displaying a plurality of chess pieces and a reinforcement card of a first game turn, the reinforcement card being configured to reinforce attributes of the chess pieces, and the reinforcement card including a reinforcement count; and reinforcing an attribute of a first chess piece in response to an operation of using the reinforcement card on the first chess piece, and displaying a first count and a first reinforcement identifier, the first reinforcement identifier being configured to represent that the attribute of the first chess piece is in a reinforced state, the first count representing a remaining count of the reinforcement count, and the first chess piece being any one or more of the plurality of chess pieces.

In an embodiment of this disclosure provides a chess piece reinforcement apparatus for a turn-based chess game, the apparatus including: a display module, configured to display a plurality of chess pieces and a reinforcement card of a first game turn, the reinforcement card being configured to reinforce attributes of the chess pieces, and the reinforcement card including a reinforcement count; and a reinforcement module, configured to reinforce an attribute of a first chess piece in response to an operation of using the reinforcement card on the first chess piece, and display a first count and a first reinforcement identifier, the first reinforcement identifier being configured to represent that the attribute of the first chess piece is in a reinforced state, the first count representing a remaining count of the reinforcement count, and the first chess piece being any one or more of the plurality of chess pieces.

In an embodiment of this disclosure provides a computer device, the computer device including a processor and a memory, the memory having at least one piece of program code stored therein, and the at least one piece of program code being loaded and executed by the processor, to cause the computer device to implement the chess piece reinforcement method for the turn-based chess game according to any one of the foregoing descriptions.

In another embodiment, a non-transitory computer-readable storage medium is further provided, the non-transitory computer-readable storage medium having at least one piece of program code stored therein, the at least one piece of program code being loaded and executed by a processor, to cause a computer to implement the chess piece reinforcement method for the turn-based chess game according to any one of the foregoing descriptions.

In another embodiment, a computer program or a computer program product is further provided, the computer program or the computer program product having at least one computer instruction stored therein, and the at least one computer instruction being loaded and executed by a processor, to cause a computer to implement any one of the foregoing chess piece reinforcement methods for the turn-based chess game.

In the technical solutions provided in the embodiments of this disclosure, a chess piece selected by a user is reinforced by using a reinforcement card, so that the user can flexibly select a chess piece to be reinforced in the first game turn, thereby improving flexibility of a reinforcement process of the chess piece. The reinforcement process is based on a game turn, and the reinforced chess piece may be determined in different game turns, to prevent the reinforcement effect of the chess piece from acting on an entire round of the game, so that flexibility and instantaneity of the chess piece reinforcement in the entire round of game may be improved, and game strategies of the user are enriched and interestingness in a game process is improved, thereby improving a man-machine interaction rate of the turn-based chess game. In addition, after the reinforcement card is used, the first reinforcement identifier may be displayed, so that the user can intuitively learn a reinforced state of the chess piece. In addition, in the game process, a battle capability of the chess piece can be improved by reinforcing the chess piece, so that duration of game playing may be reduced to some extent, and efficiency of the game playing is improved, thereby saving computer resources.

### BRIEF DESCRIPTION OF THE DRAWINGS

FIG. 1 is a block diagram of a structure of a computer system for performing a chess piece reinforcement method for a turn-based chess game according to an embodiment of this disclosure.

FIG. 2 is a flowchart of a chess piece reinforcement method for a turn-based chess game according to an embodiment of this disclosure.

FIG. 3 is a schematic diagram of a first game turn interface according to an embodiment of this disclosure.

FIG. 4 is a schematic diagram of a battle stage interface according to an embodiment of this disclosure.

FIG. 5 is a schematic diagram of a process of a card obtaining interface according to an embodiment of this disclosure.

FIG. 6 is a schematic diagram of a process of a card obtaining interface including a reinforcement prop according to an embodiment of this disclosure.

FIG. 7 is a schematic diagram of a first game turn interface including a reinforcement process of a first chess piece according to an embodiment of this disclosure.

FIG. 8 is a schematic diagram of a process of a first game turn interface including a first reinforcement identifier and a first count according to an embodiment of this disclosure.

FIG. 9 is a schematic diagram of a process of a game turn interface including second prompt information according to an embodiment of this disclosure.

FIG. 10 is a flowchart of another chess piece reinforcement method for a turn-based chess game according to an embodiment of this disclosure.

FIG. 11 is a schematic diagram of a structure of a chess piece reinforcement apparatus for a turn-based chess game according to an embodiment of this disclosure.

FIG. 12 is a block diagram of a structure of a terminal device according to an embodiment of this disclosure.

FIG. 13 is a schematic diagram of a structure of a server according to an embodiment of this disclosure.

### DETAILED DESCRIPTION

To make objectives, technical solutions, and advantages of this disclosure clearer, implementations of this disclosure are described in further detail with reference to accompany drawings.

Descriptions of terms in this disclosure are provided as examples only and are not intended to limit the scope of the disclosure.

Turn-based chess game: A turn-based chess game may be a chess game in which “chess pieces” are arranged in advance before a chess battle begins, and during the battle, the “chess pieces” can automatically battle according to the preset arrangement. The “Chess pieces” may be represented by virtual objects, for example, may be referred to as virtual heroes. During the battle, the virtual objects may automatically release various types of skills to battle. A battle may be turn-based. When “chess pieces” of one party of the battle are all lost (for example, health points of the virtual objects are reduced to zero), this party may be a failing party of the battle in this turn. In some embodiments, in addition to the “chess-piece-type virtual objects” that play the game, each of the two opposing parties may respectively have a chess player role representing a current user participating in the battle. In some examples, the chess player role may not be used as a “chess piece” to be moved to a battle region or a candidate chess piece region. The chess player role may be also set with a health point (or a blood volume). The health point of the chess player role may be correspondingly reduced (the battle fails) or unchanged (the battle wins) according to a battle result of each round. When the health point of the chess player role is reduced to zero, the user corresponding to the chess player role may exit the battle, and remaining users continue to battle. In some embodiments, the turn-based chess game includes an auto chess.

Auto chess: The auto chess may be a multi-player turn-based arena game featuring in-match collectible hero chess pieces. For example, there are a total of eight or six users (which may also be referred to as players) in the game, and each of the users occupies a region on a chessboard. Two users of the plurality of users may engage in a one-to-one battle. In one round of the battle, each turn may include a preparation stage and a battle stage. At the preparation stage, the user may purchase chess pieces (heroes) in a shop and arrange the chess pieces (heroes) on the chessboard. At the battle stage, arrangements of the two parties may be locked, and chess pieces automatically engage in combat until all chess pieces of one party are dead. The user whose chess pieces are all eliminated may be a defeated party of this turn, and a particular blood volume of the user is deducted. Continuously the game turns may be repeated and new opponents matched, until the user is knocked out when the health point of the user≤0. Finally, in some examples only one survived user will win the game (wins the first place).

Chessboard: A chessboard may be a region configured to prepare a battle and fighting a battle in a battle interface of the turn-based chess game. The chessboard may be any one of a two-dimensional virtual chessboard, a 2.5-dimensional virtual chessboard, and a three-dimensional virtual chessboard.

Attribute: In an auto chess game, attributes of a chess piece may include a basic attribute and a functional attribute, where the basic attribute includes, but is not limited to, a health point, mana, an attack force, a spell power, an armor, magic resistance, an attack speed, and an attack distance of the chess piece; and the functional attribute includes, but is not limited to, an economic gain and free refreshing of the chess piece in a game turn. The attributes of the chess piece may affect a battle capability of the chess piece. A stronger attribute of the chess piece may indicate a larger probability of winning the game playing. In some embodiments, the basic attribute may also be referred to as a fundamental attribute.

Chess player: The chess player may be a virtual character played by a user. Each chess player may have different special capabilities, which can help the user play the game better. In some embodiments, the chess player may also be referred to as a chess player role, a virtual chess player character, a virtual character, a little hero, or the like.

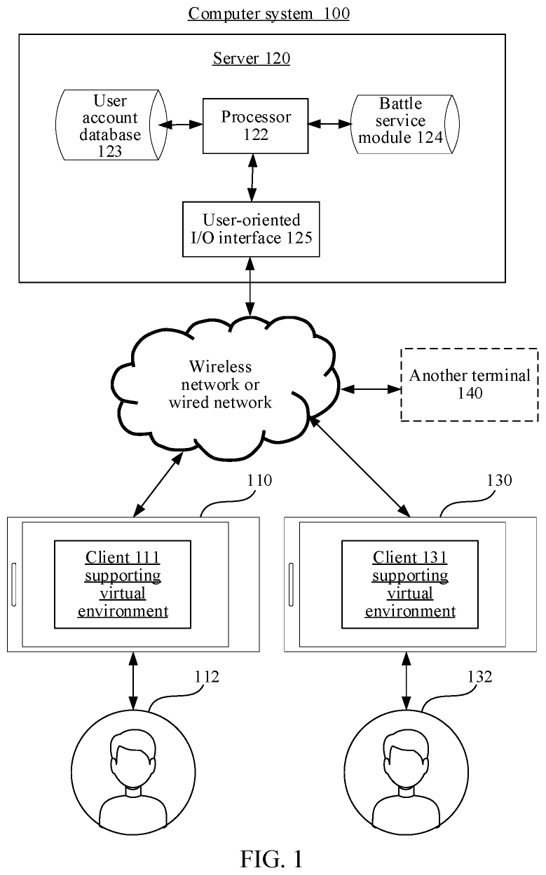

FIG. 1 is a block diagram of a structure of a computer system for performing a chess piece reinforcement method for a turn-based chess game according to an embodiment of this disclosure. A computer system 100 includes: a first terminal 110, a server 120, and a second terminal 130.

A client 111 supporting a virtual environment is installed and run on the first terminal 110. The client 111 may be a turn-based chess game program. When the first terminal 110 runs the client 111, a user interface of the client 111 is displayed on a screen of the first terminal 110. The client 111 may be a client of an auto chess game. The first terminal 110 is a terminal used by a first user 112. The first user 112 obtains chess pieces by using the first terminal 110 at a preparation stage of game playing and arranges the chess pieces in a battle region of a chessboard. The first terminal 110 or the server 120 automatically controls the chess pieces to battle at a battle stage according to attributes, skills, and arrangements of the chess pieces in the battle region.

A client 131 supporting a virtual environment is installed and run on the second terminal 130. The client 131 may be a turn-based chess game program. When the second terminal 130 runs the client 131, a user interface of the client 131 is displayed on a screen of the second terminal 130. The client 131 may be a client of an auto chess game. The second terminal 130 is a terminal used by a second user 132. The second user 132 obtains chess pieces by using the second terminal 130 at the preparation stage of the game playing, and arranges the chess pieces in a battle region of the chessboard. The second terminal 130 or the server 120 automatically controls the chess pieces to battle at the battle stage according to attributes, skills, and arrangements of the chess pieces in the battle region.

The virtual environment refers to an environment provided (or displayed) when a client is run on a terminal, and the virtual environment may be a two-dimensional virtual environment, a 2.5-dimensional virtual environment, a three-dimensional virtual environment, or the like. The virtual environment may be a simulated environment of the real world, a semi-simulated environment of the real world, or a purely fictional environment. In some embodiments, the virtual environment may also be referred to as a virtual scenario, a virtual world, or the like.

In some embodiments, the chess pieces arranged by the first user 112 by using the first terminal 110 and the chess pieces arranged by the second user 132 by using the second terminal 130 are located in different battle regions on the same chessboard, for example, the first user 112 and the second user 132 are located on the same chessboard of same game playing. Alternatively, the chess pieces arranged by the first user 112 by using the first terminal 110 and the chess pieces arranged by the second user 132 by using the second terminal 130 are located on different chessboards, for example, the first user 112 and the second user 132 are located on different chessboards of the same game playing. In an example embodiment, eight user accounts jointly participate in game playing of the turn-based chess game, two of the eight user accounts are matched in pairs in each turn, and two matched user accounts battle against each other in the same chessboard in this turn.

In some embodiments, the client installed on the first terminal 110 is the same as the client installed on the second terminal 130, or the clients installed on the two terminals are of the same type but on different operating system platforms. The first terminal 110 may refer to one of a plurality of terminals, and the second terminal 130 may refer to another one of the plurality of terminals. In this embodiment, only the first terminal 110 and the second terminal 130 are used as an example for description. A device type of the first terminal 110 may be the same as or different from a device type of the second terminal 130, and the device type includes: at least one of a smartphone, a tablet computer, an e-book reader, a moving picture experts group audio layer III (MP3) player, a moving picture experts group audio layer IV (MP4) player, a laptop portable computer, or a desktop computer. An example in which the terminal includes the smartphone is used for description in the following embodiments.

A person skilled in the art may learn that a quantity of foregoing terminals may be more or fewer. For example, the quantity of foregoing terminals may be only one (for example, a user plays a game against artificial intelligence), or the quantity of foregoing terminals may be six or eight or more. This embodiment of this disclosure does not limit the quantity of terminals and the device type.

FIG. 1 shows only two terminals. However, there are a plurality of other terminals 140 that can access the server 120 in different embodiments. In some embodiments, there are also one or more terminals 140 that correspond to a developer. A development and editing platform of the client supporting the virtual environment is installed on the terminal 140. The developer may edit and update the client on the terminal 140, and transmit an installation package of the updated client to the server 120 through a wired or wireless network. The first terminal 110 and the second terminal 130 may download the installation package of the client from the server 120 to update the client.

The first terminal 110, the second terminal 130, and the another terminal 140 are connected to the server 120 through a wired or wireless network.

The server 120 includes at least one of one server, a plurality of servers, a cloud computing platform, or a virtualization center. The server 120 is configured to provide a backend service for the client (for example, the client of the turn-based chess game/the client of the auto chess game) supporting the virtual environment. In some embodiments, the server 120 is responsible for primary computing work, and the terminal is responsible for secondary computing work; or the server 120 is responsible for secondary computing work, and the terminal is responsible for primary computing work; or a distributed computing architecture is adopted between the server 120 and the terminal to perform collaborative computing.

In an example, the server 120 includes a processor 122, a user account database 123, a battle service module 124, and a user-oriented input/output interface (I/O interface) 125. The processor 122 is configured to load instructions stored in the server 120, and process data in the user account database 123 and data in the battle service module 124. The user account database 123 is configured to store data of user accounts used by the first terminal 110, the second terminal 130, and the another terminal 140, such as avatars of the user accounts, nicknames of the user accounts, fighting power indexes of the user accounts, and service areas of the user accounts. The battle service module 124 is configured to provide a plurality of battle rooms for users to battle. The user-oriented I/O interface 125 is configured to establish communication with the first terminal 110 and/or the second terminal 130 through a wireless network or a wired network for data exchange.

An example in which the first terminal 110 runs the turn-based chess game is used as an example for description. During the turn-based chess game, the chess pieces of the two parties engage in combat, and the chess pieces may have attributes. The stronger the attributes of the chess pieces, the better the battle capabilities, leading to a higher probability of winning the battle. Therefore, during the combat between the two parties, the attributes of the chess pieces need to be reinforced by using a reinforcement card. The reinforcement card may have a reinforcement level, and different levels of reinforcement cards correspond to different reinforcement counts. An example in which the reinforcement card is used on a first chess piece in a first game turn is used for description. In the first game turn, the user may select the first chess piece from a plurality of chess pieces, and uses the reinforcement card on the first chess piece. After the reinforcement card is used, an attribute of the first chess piece is reinforced, and the first chess piece may be in a reinforced state. In this case, a first reinforcement identifier and a first count may be displayed in a first game turn interface. The first reinforcement identifier represents that the first chess piece is in the reinforced state, and the first count represents a quantity of times that the reinforcement card may be used. In a subsequent game turn, a reinforcement process of the chess piece in the first game turn may be repeated until this round of the game ends. The chess piece selected by the user is reinforced in the single game turn, for example, the reinforced state of the chess piece acts on the current game turn rather than the entire round of game, enabling the user to complete reinforcement processes of a plurality of chess pieces in the entire round of game, so that flexibility and interestingness of chess piece reinforcement in the entire round of game are improved, thereby improving a man-machine interaction rate of the turn-based chess game.

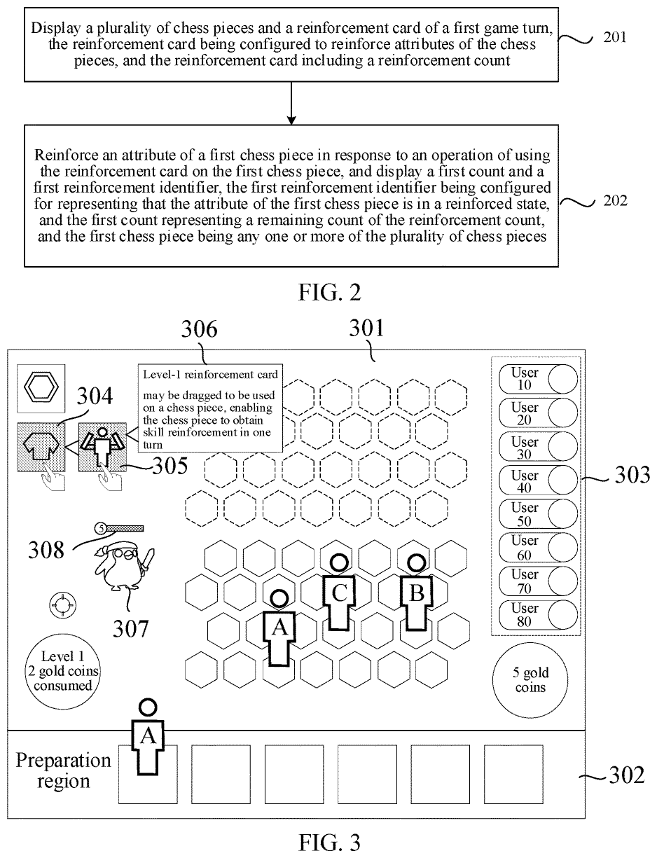

The chess piece reinforcement method for the turn-based chess game provided in this embodiment of this disclosure may be applied to the computer system shown in FIG. 1. The method may be performed by a computer device. The computer device may include the terminals (for example, the first terminal 110 and the second terminal 130) in FIG. 1, or may include the server 120 in FIG. 1. For example, the method may be performed by the first terminal 110 and the second terminal 130 in FIG. 1, or may be interactively performed by the first terminal 110, the server 120, and the second terminal 130. An example in which the first terminal 110 and the second terminal 130 perform the method is used. As shown in FIG. 2, the method includes the following operation 201 and operation 202.
Operation 201: Display a plurality of chess pieces and a reinforcement card of a first game turn, where the reinforcement card is configured to reinforce attributes of the chess pieces, and the reinforcement card includes a reinforcement count. In an example, a plurality of chess pieces and a reinforcement card are displayed on a first game turn, the reinforcement card being configured to reinforce at least one attribute of the chess pieces and is associated with a reinforcement count.

For example, an implementation of displaying the plurality of chess pieces and the reinforcement card of the first game turn may be: displaying a first game turn interface, where the first game turn interface includes the plurality of chess pieces and the reinforcement card. The first game turn interface is an interface of the first game turn.

In an example embodiment of this disclosure, the first game turn interface is an interface of any game turn displayed through terminals corresponding to a first user and a second user, for example, the first game turn may be any game turn in a game process. The first game turn interface may include a preparation stage and a battle stage of the current game turn. An example in which the first game turn interface is the battle stage of the current game turn is used for description. The first game turn interface may include a preparation region, a battle region, and a prop bar. The battle region displays a chessboard of a user party and a chessboard of an enemy party, the chessboard of the user party includes a chess piece of the user party that is already in battle, and the chessboard of the enemy party includes a chess piece of the enemy party that is already in battle. The preparation region includes a chess piece that is possessed by the user party but is not in battle. The prop bar includes a virtual prop already obtained by the user party, and the virtual prop is configured to be used in game playing.

The plurality of chess pieces are displayed in the preparation region and the battle region. The chess pieces may be virtual objects having particular shapes, or may be cards. Related information of the chess pieces may be displayed in the cards, and the related information of the chess pieces may include at least one of basic attributes or functional attributes of the chess pieces. The virtual prop in the prop bar may include the reinforcement card. The reinforcement card is configured to reinforce the attributes of the chess pieces. For example, the reinforcement card may have a reinforcement level, and different levels of reinforcement cards may have different reinforcement counts, and the reinforcement count is a quantity of times that the reinforcement card may be used. For example, the higher the level of the reinforcement card, the larger the corresponding reinforcement count.

In some embodiments, a virtual character may also be displayed in the first game turn interface. The virtual character is a character controlled by the user, and may also be referred to as a chess player or a little hero. The virtual character may have an attribute value. When the current game turn ends, the attribute value of the virtual character may be adjusted based on a game result of the current turn. In the first game turn interface, the attribute value of the virtual character may be displayed, or the attribute value of the virtual character may not be displayed. For example, the attribute value of the virtual character may be a blood volume of the virtual character, and the blood volume corresponding to the virtual character may be displayed around the virtual character in the first game turn interface. A display manner of the blood volume may include but is not limited to a bar display, a ring display, or a numerical display. When different users play the game in the game turn, for a user that fails in the game playing, a part of a blood volume of a virtual character of the user may be deducted; and for a user that wins the game playing, a blood volume of a virtual character of the user may be kept unchanged, or a part of a blood volume may be added for a virtual character of the user.

In some embodiments, the first game turn interface may also include an information display region, and the information display region is configured to present information related to the user. For example, an avatar of the user account and a nickname of the user account may be displayed in the information display region. In some embodiments, the information display region may also be referred to as an information presentation region, a user information presentation region, or the like. In some embodiments, the user may also be referred to as a player, an interaction object, a game object, a virtual object user, or the like.

In this disclosure, the display content of the first game turn interface is only example description, and may also be set based on an actual situation in a game process. This is not limited in this disclosure.

FIG. 3 is a schematic diagram of a first game turn interface according to an embodiment of this disclosure. As shown in FIG. 3, the first game turn interface includes a battle region 301 and a preparation region 302. The battle region 301 displays a chessboard (a solid line part) of a user party and a chessboard (a dashed line part) of an enemy party. The chessboard of the user party includes a chess piece A, a chess piece B, and a chess piece C of the user party that are already in battle. The preparation region 302 includes a chess piece A that is possessed by the user party but is not in battle. The first game turn interface also includes a user information presentation region 303. Information about a user participating in a game may be presented in the user information presentation region 303, for example, an avatar of a user account and a nickname of the user account may be presented. The first game turn interface may also include a prop bar 304. The prop bar 304 stores a virtual prop that may be used in a current game turn. For example, the prop bar 304 may store a reinforcement card prop 305. The reinforcement card prop 305 may include at least one reinforcement card 306. The reinforcement card 306 has a level of level 1, and is configured to reinforce an attribute of any one chess piece of the chess piece A, the chess piece B, and the chess piece C of the user party that are already in battle. The first game turn interface may also display a virtual character 307 and a blood volume 308 corresponding to the virtual character 307. The virtual character 307 is a character controlled by the user. After the current game turn ends, the blood volume 308 of the virtual character may be adjusted based on a game result of the current game turn.

In an example embodiment of this disclosure, before the reinforcement card is used, the reinforcement card may be obtained. In some embodiments, a manner of obtaining the reinforcement card may be purchasing a reinforcement card. In some other embodiments, a manner of obtaining the reinforcement card may alternatively be receiving a reinforcement card given by another user as a gift. In some other embodiments, a manner of obtaining the reinforcement card may alternatively be obtaining a reinforcement card by completing a particular task.

For example, a process of obtaining the reinforcement card may include: displaying at least one reinforcement card in response to an obtaining operation of the reinforcement card; and allocating a selected reinforcement card to the virtual character when the virtual character meets an obtaining condition of the reinforcement card, and the reinforcement card is selected, where the virtual character is configured to control a plurality of chess pieces.

For example, an implementation of displaying at least one reinforcement card in response to the obtaining operation of the reinforcement card may be: displaying a card obtaining interface in response to the obtaining operation of the reinforcement card, where the card obtaining interface includes at least one reinforcement card.

For example, in any game turn, the user may obtain the reinforcement card. For example, an obtaining control may be displayed in a battle stage interface. The battle stage interface may be an interface displaying a battle process of the two parties, and the battle stage interface may include the first game turn interface. The obtaining control is configured to purchase the reinforcement card. After the obtaining control is triggered, the obtaining operation of the reinforcement card may be generated, and then the card obtaining interface may be displayed. For example, the card obtaining interface is a game mall interface.

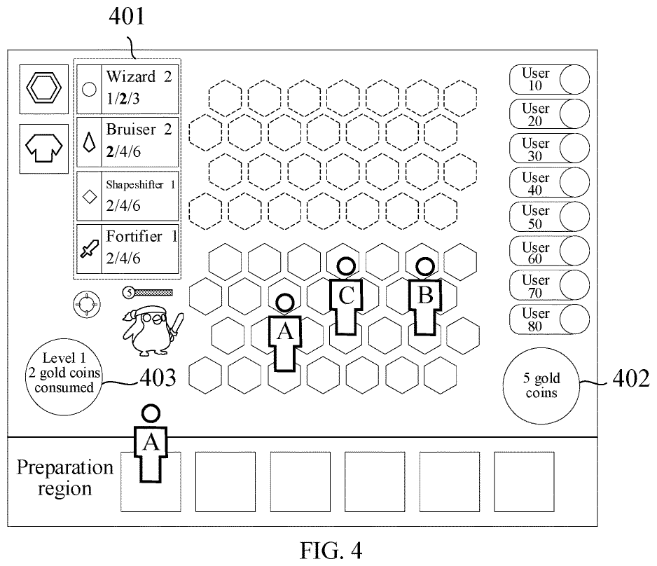

FIG. 4 is a schematic diagram of a battle stage interface according to an embodiment of this disclosure. As shown in FIG. 4, the battle stage interface may include bond information 401, an obtaining control 402, and an upgrade control 403. The bond information 401 is a bond corresponding to a chess piece. When a quantity of chess pieces belonging to the same bond reaches a quantity threshold, the bond may be activated, and an additional gain effect may be generated on the chess piece after the bond is activated. The obtaining control 402 is a virtual gold coin control, representing a quantity of virtual gold coins currently possessed by a user of a user party. After the obtaining control 402 is triggered, a card obtaining interface may be displayed. The upgrade control 403 is configured to upgrade the chess piece, and a quantity of virtual gold coins required to be consumed for upgrade is also displayed in the upgrade control 403. Other information in the battle stage interface is already described in further detail in the description of the first game turn interface, so that reference may be made to related descriptions in FIG. 3, and details are not described herein again.

After the obtaining control is triggered, the card obtaining interface is displayed, and at least one reinforcement card may be displayed in the card obtaining interface. Reinforcement information may be displayed on the reinforcement card, and the reinforcement information may include, but is not limited to, at least one of a reinforcement count, a reinforcement level, a reinforcement attribute, a reinforcement attribute effect, or a reinforcement virtual resource, and the reinforcement count is in positive correlation with at least one of the reinforcement level, the reinforcement attribute effect, or the reinforcement virtual resource.

For example, the reinforcement count is a quantity of times that the current reinforcement card may be used. The reinforcement level is a level of the current reinforcement card. The reinforcement attribute is an attribute of the current reinforcement card that can be reinforced, and the reinforcement attribute may be set according to experience, or may be flexibly adjusted according to a requirement. This is not limited in this embodiment of this disclosure. For example, attributes of a chess piece may include a basic attribute and a functional attribute. The reinforcement attribute may include at least one of the basic attributes, or may include at least one of the functional attributes, or may include at least one of the basic attributes and at least one of the functional attributes. The reinforcement attribute effect may be a reinforcement effect that the current reinforcement card may have on the attributes of the chess piece, and the attributes of the chess piece may include the basic attribute and the functional attribute. The reinforcement attribute effect may be an effect of reinforcing the basic attribute of the chess piece, or may be an effect of reinforcing the functional attribute of the chess piece. The reinforcement virtual resource may be a virtual resource required for obtaining the reinforcement card, or may be referred to as a fee required for obtaining the reinforcement card. A type of virtual resource required for obtaining the reinforcement card is not limited in this embodiment of this disclosure. For example, the type of virtual resource required for obtaining the reinforcement card may include a virtual gold coin.

For example, a higher reinforcement level corresponding to the reinforcement card indicates a larger reinforcement count; and a better reinforcement attribute effect of the reinforcement card on the chess piece indicates a higher cost required for purchasing the reinforcement card. For example, a reinforcement count of a level 1 reinforcement card is one, and a reinforcement count corresponding to a level 2 reinforcement card is two; the reinforcement card may reinforce a health point of the chess piece, the level 1 reinforcement card may add 50 health points for the chess piece per use, and the level 2 reinforcement card may add 60 health points for the chess piece per use; and two virtual gold coins are required for obtaining the level 1 reinforcement card, and four virtual gold coins are required for obtaining the level 2 reinforcement card.

In this embodiment of this disclosure, an association relationship between the reinforcement count, the reinforcement level, the reinforcement attribute effect, and the reinforcement virtual resource is not limited, as long as it is ensured that at least one of the reinforcement level, the reinforcement attribute effect, or the reinforcement virtual resource is in positive correlation with the reinforcement count. In some embodiments, the reinforcement level, the reinforcement attribute effect, or the reinforcement virtual resource is in positive correlation with the reinforcement count. In some embodiments, both the reinforcement level and the reinforcement attribute effect are in positive correlation with the reinforcement count. In some embodiments, both the reinforcement attribute effect and the reinforcement virtual resource are in positive correlation with the reinforcement count. In some embodiments, both the reinforcement level and the reinforcement virtual resource are in positive correlation with the reinforcement count. In some embodiments, the reinforcement level, the reinforcement attribute effect, and the reinforcement virtual resource are all in positive correlation with the reinforcement count.

When the reinforcement level is in positive correlation with the reinforcement count, a larger reinforcement count indicates a higher reinforcement level. When the reinforcement attribute effect is in positive correlation with the reinforcement count, a larger reinforcement count indicates a better reinforcement attribute effect. When the reinforcement virtual resource is in positive correlation with the reinforcement count, a larger reinforcement count indicates more reinforcement virtual resources.

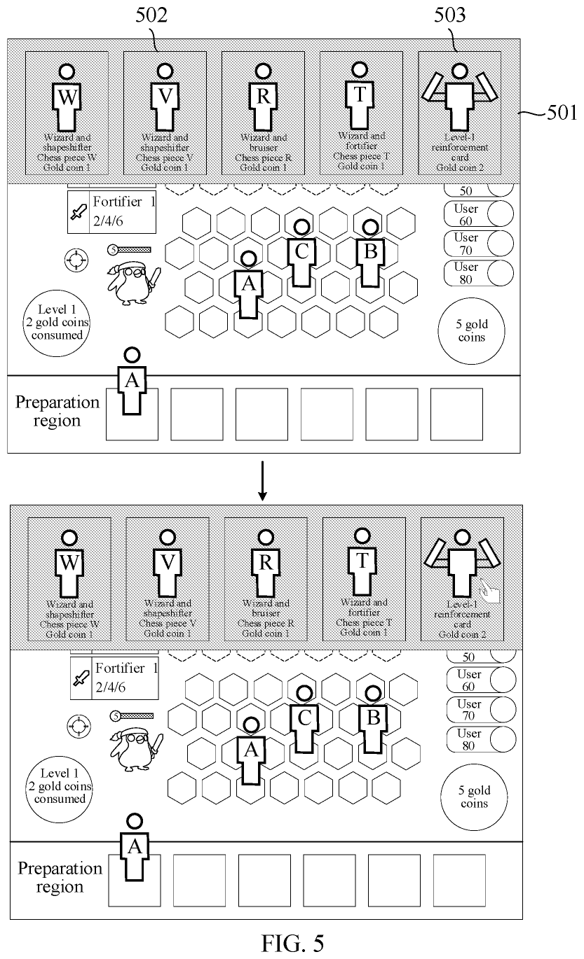

FIG. 5 is a schematic diagram of a process of a card obtaining interface according to an embodiment of this disclosure. As shown in FIG. 5, the card obtaining interface may include a card presentation region 501, and the card presentation region 501 may include a chess piece card 502 and a reinforcement card 503. A bond type of a chess piece, a name of the chess piece, and a quantity of virtual gold coins required to be consumed for purchasing the chess piece may be displayed on the chess piece card 502. For example, the chess piece card 502 may include a chess piece card W, a chess piece card V, a chess piece card R, and a chess piece card T. Using the chess piece card W as an example, a bond type of a chess piece W is a wizard and a shapeshifter, and a name of the chess piece W is the chess piece W, and one virtual gold coin is required to be consumed for purchasing the chess piece card W. A reinforcement level and a quantity of virtual gold coins required for obtaining the reinforcement card may be displayed on the reinforcement card 503. For example, a reinforcement level of the current reinforcement card 503 is level 1, and two virtual gold coins are required for purchasing the reinforcement card 503.

In this disclosure, the chess piece information displayed in the chess piece card and the reinforcement information displayed in the reinforcement card are example descriptions. Chess piece information such as a level of the chess piece and an attribute of the chess piece may also be displayed on the chess piece card, and reinforcement information such as a reinforcement count and a reinforcement attribute may also be displayed on the reinforcement card, which may be set based on a game process. This is not limited in this disclosure.

The foregoing descriptions are merely described by using an example in which a user triggers an obtaining operation of the reinforcement card by triggering an obtaining control. This embodiment of this disclosure is not limited thereto. In some embodiments, a manner in which the user triggers the obtaining operation of the reinforcement card may further include: the user utters a reinforcement card obtaining voice, the user makes a reinforcement card obtaining gesture, the user generates a particular operation in a controller, and the like. The reinforcement card obtaining voice is a voice configured to obtain the reinforcement card. The reinforcement card obtaining gesture is a gesture configured to obtain the reinforcement card. The particular operation generated in the controller is an operation configured to obtain the reinforcement card. The reinforcement card obtaining voice, the reinforcement card obtaining gesture, and the particular operation may be set according to experience, or may be set flexibly according to a requirement. This is not limited in this embodiment of this disclosure.

In an example embodiment of this disclosure, in a process of obtaining the reinforcement card, whether a virtual character meets an obtaining condition of the reinforcement card may further be determined. The virtual character is a character controlled by the user, and the user may control the virtual character to perform an operation in the game. For example, the user may control the virtual character to purchase a chess piece card, purchase a reinforcement card, and the like.

The obtaining condition may include but is not limited to at least one of: a quantity of reinforcement cards possessed by the virtual character is less than a quantity threshold; a quantity of virtual gold coins possessed by the virtual character is greater than or equal to a quantity of virtual gold coins required for obtaining the current reinforcement card; a level of the virtual character is higher than or equal to a level required for obtaining the current reinforcement card; an attribute value of the virtual character is greater than an attribute value threshold; or a type of the virtual character is a particular type. When the virtual character meets the obtaining condition of the reinforcement card, a selected reinforcement card is allocated to the virtual character in response to a selection operation of the reinforcement card. For example, the selection operation of the reinforcement card includes, but is not limited to, a single-click/tap operation, a double-click/tap operation, and a long-press operation on the reinforcement card. For example, as shown in FIG. 5, the user may select the reinforcement card by clicking/tapping the reinforcement card once.

In a technical solution provided in this embodiment of this disclosure, in the process of obtaining the reinforcement card, whether the virtual character meets the obtaining condition of the reinforcement card is determined. For example, when the quantity of cards possessed by the virtual character is less than or equal to the threshold, and the quantity of virtual gold coins possessed by the virtual character is greater than or equal to the quantity of virtual gold coins required for obtaining the reinforcement card, the reinforcement card can be purchased. Whether the virtual character meets the obtaining condition of the reinforcement card is determined, to balance economy of the user and the attribute of the chess piece to some extent, thereby improving strategy and balance of the game.

In an example embodiment of this disclosure, after the selected reinforcement card is allocated to the virtual character, a reinforcement prop may be displayed, and the reinforcement prop is associated with the selected reinforcement card; and the selected reinforcement card is displayed in response to a trigger operation of the reinforcement prop.

For example, in the process of obtaining the reinforcement card, after the reinforcement card is allocated to the virtual character, the reinforcement prop may be displayed in the card obtaining interface. For example, the reinforcement prop may be a reinforcement ball. In the card obtaining interface, the reinforcement ball may be in a static state, or may be in a movement state. The user may control the virtual character to trigger the reinforcement ball, and after the reinforcement ball is triggered, the user may obtain a reinforcement card associated with the reinforcement ball, and stores the reinforcement card to a prop bar. For example, the trigger operation of the reinforcement ball may include, but is not limited to, a single-click/tap operation, a double-click/tap operation, and a long-press operation performed by the virtual character on the reinforcement ball, and the virtual character is located in a reinforcement ball obtaining region. The reinforcement ball obtaining region refers to a region in which the reinforcement ball can be obtained. For example, the reinforcement ball obtaining region may refer to a region in which the reinforcement ball is located; may refer to a region obtained by expanding, by a particular size, a region in which the reinforcement ball is located, with the region as the center of the expanding; or the like.

The reinforcement ball is merely an example description of the reinforcement prop, and this embodiment of this disclosure is not limited thereto. The reinforcement prop may alternatively be a prop in another form. For example, the reinforcement prop may alternatively be a backpack-form prop, a flying-disc-form prop, or the like.

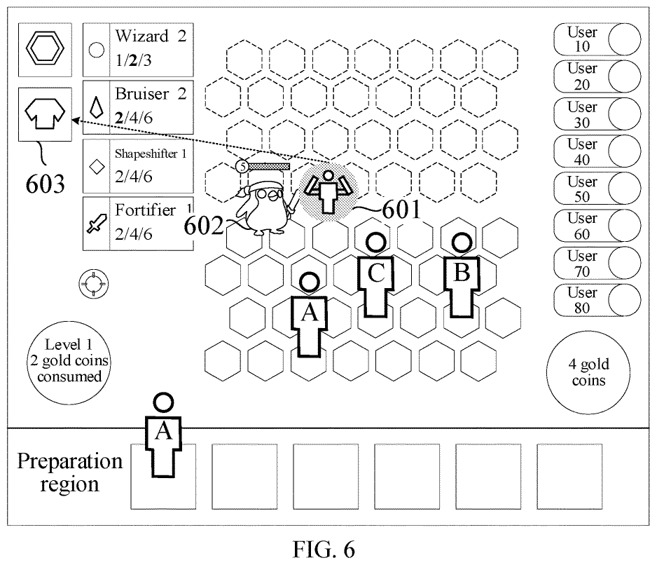

FIG. 6 is a schematic diagram of a process of a card obtaining interface including a reinforcement prop according to an embodiment of this disclosure. As shown in FIG. 6, after a user purchases a reinforcement card, a reinforcement prop 601 may be displayed in the card obtaining interface. The reinforcement prop 601 is associated with the reinforcement card purchased by the user. The user controls a virtual character 602 to trigger the reinforcement prop 601. After the reinforcement prop 601 is triggered, the reinforcement card associated with the reinforcement prop 601 may be added to a prop bar 603.

In a technical solution provided in this embodiment of this disclosure, in a process of obtaining the reinforcement card, the reinforcement prop is generated, and after the virtual character triggers the reinforcement prop, the reinforcement card associated with the virtual prop is obtained, so that interestingness and a man-machine interaction rate in the process of obtaining the reinforcement card may be improved.

In an example embodiment of this disclosure, when a refresh control is still displayed, a refreshed reinforcement card is displayed in response to a trigger operation of the refresh control. For example, both the refresh control and the refreshed reinforcement card are displayed in the card obtaining interface. In other words, the card obtaining interface may further include the refresh control. In response to the trigger operation of the refresh control, the refreshed reinforcement card is displayed in the card obtaining interface. For example, the trigger operation of the refresh control may include, but is not limited to, a single-click/tap operation, a double-click/tap operation, and a long-press operation on the refresh control. In a process of purchasing the reinforcement card by the user, if the reinforcement card displayed in the card obtaining interface is not a reinforcement card required by the user, the user may refresh the reinforcement card in the card obtaining interface by using the refresh control.

For example, when the refresh control is still displayed and a refresh count is not greater than a refresh count threshold, the refreshed reinforcement card is displayed in response to the trigger operation of the refresh control. The refresh count threshold may be set according to experience, or may be flexibly adjusted according to a requirement. This is not limited in this embodiment of this disclosure. For example, the refresh count threshold may be 10. Before a refresh operation is performed on the reinforcement card, a refresh count of the reinforcement card in a current game turn may be obtained. If the refresh count of the reinforcement card in the current game turn is less than or equal to the refresh count threshold, the refreshed reinforcement card may be displayed in the card obtaining interface; or if the refresh count of the reinforcement card in the current game turn is greater than the refresh count threshold, the refresh operation of the reinforcement card is not performed in the card obtaining interface.

In the technical solution provided in this embodiment of this disclosure, the reinforcement card displayed in the card obtaining interface is refreshed by using the refresh control, so that a chance of obtaining a desired reinforcement card may be increased for the user. In a subsequent game process, a game strategy may be properly formulated by using the reinforcement card, so that strategy and user experience of the game may be improved to some extent, thereby improving a man-machine interaction rate.

An upper limit of the refresh count is limited, which can avoid resource waste caused by infinite refreshes of the user, and is conducive to ensuring fairness of the game, so that game experience of the user is improved, and the man-machine interaction rate is further improved.

The foregoing descriptions only use an example in which the refreshed reinforcement card is displayed based on the trigger operation of the refresh control for description, and this embodiment of this disclosure is not limited thereto. In some embodiments, a manner of displaying the refreshed reinforcement card may further include: displaying the refreshed reinforcement card based on a refresh voice, displaying the refreshed reinforcement card based on a refresh gesture, displaying the refreshed reinforcement card based on a refresh operation generated in a controller, and the like. The refresh voice is a voice that is uttered by the user and that is configured to refresh the reinforcement card. The refresh gesture is a gesture that is made by the user and that is configured to refresh the reinforcement card. The refresh operation is an operation that is generated by the user in the controller and that is configured to refresh the reinforcement card. The refresh voice, the refresh gesture, and the refresh operation may be set according to experience, or may be flexibly adjusted according to a requirement. This is not limited in this embodiment of this disclosure.

In an example embodiment of this disclosure, in the process of obtaining the reinforcement card, statistics about a quantity of reinforcement cards possessed by the virtual character may also be collected. When the quantity of reinforcement cards already possessed by the virtual character is greater than or equal to a quantity threshold, first prompt information is displayed in response to the obtaining operation of the reinforcement card, and the first prompt information is configured to guide the user to use the reinforcement card already possessed by the virtual character.

For example, in any game turn process, the user may control the virtual character to obtain a plurality of reinforcement cards. In the process of obtaining the reinforcement card, statistics about the quantity of reinforcement cards already possessed by the virtual character may be collected. When the quantity of reinforcement cards already possessed by the virtual character is less than the quantity threshold, the reinforcement card may be obtained. The process of obtaining the reinforcement card is already described above, and details are not described herein again. When the quantity of reinforcement cards possessed by the virtual character is greater than or equal to the quantity threshold, after the obtaining operation of the reinforcement card is detected, the first prompt information may be displayed in the card obtaining interface. The first prompt information is configured to guide the user to preferentially use the reinforcement cards already possessed by the virtual character. For example, the first prompt information may be “You already have three reinforcement cards now, and you may obtain a new reinforcement card after the reinforcement cards that are already possessed are used or sold.”

In the technical solution provided in this embodiment of this disclosure, in the process of obtaining the reinforcement card, after the virtual character possesses a particular quantity of reinforcement cards, the user may preferentially use the reinforcement cards that are already possessed under guidance of the first prompt information, to prevent the user from obtaining the reinforcement cards excessively, so as to ensure that the user can properly obtain and effectively use game resources.
Operation 202: Reinforce an attribute of a first chess piece in response to an operation of using the reinforcement card on the first chess piece, and display a first count and a first reinforcement identifier, the first reinforcement identifier being configured to represent that the attribute of the first chess piece is in a reinforced state, the first count being configured to represent a remaining count of the reinforcement count, and the first chess piece being any one or more of the plurality of chess pieces. In an example, an attribute of a first chess piece of the plurality of chess pieces is reinforced based on use of the reinforcement card with the first chess piece and a first count and a first reinforcement identifier are displayed, the first reinforcement identifier representing that the attribute of the first chess piece is in a reinforced state, and the first count representing a remaining count of the reinforcement count.

For example, the displayed first count and the displayed first reinforcement identifier refer to a first count and a first reinforcement identifier that are displayed in the first game turn interface.

In an example embodiment of this disclosure, when the virtual character possesses the reinforcement card, the reinforcement card may be used on the chess pieces displayed in the first game turn interface, to reinforce the attributes of the chess pieces. For example, a first chess piece in the plurality of chess pieces displayed in the first game turn interface is reinforced, and the first chess piece is a chess piece selected by the user, and the first chess piece may be any one or more of the plurality of chess pieces.

A process of reinforcing an attribute of the first chess piece may include: determining a first attribute corresponding to a first reinforcement attribute from a plurality of attributes of the first chess piece; and determining, based on the first attribute, an attribute that is of the first chess piece and that is in a reinforced state.

The first reinforcement attribute is a reinforcement attribute corresponding to the reinforcement card. Before the attribute of the chess piece is reinforced, the first reinforcement attribute may be further determined. Determining the first reinforcement attribute may include the following two cases.

Case one: The reinforcement card has one reinforcement attribute. The reinforcement card may be in a one-to-one correspondence with the reinforcement attribute, for example, the reinforcement card may reinforce one attribute of the chess piece, and the reinforcement attribute corresponding to the reinforcement card may be used as the first reinforcement attribute. For example, if the reinforcement attribute corresponding to the reinforcement card is a health point, after the reinforcement card is used, a health point of the chess piece can be reinforced, and other attributes of the chess piece remain unchanged.

Case 2: The reinforcement card has a plurality of reinforcement attributes. The reinforcement card may be associated with the plurality of reinforcement attributes, and the user may freely select one reinforcement attribute from the plurality of reinforcement attributes as the first reinforcement attribute. For example, the reinforcement card may be configured to reinforce a health point, an attack force, and a defense power of the chess piece, and the user may select one attribute from the three attributes as the first reinforcement attribute corresponding to the reinforcement card.

After the first reinforcement attribute corresponding to the reinforcement card is determined, the first attribute corresponding to the first reinforcement attribute may be determined from the plurality of attributes of the first chess piece. For example, the first attribute is an attribute that is in the plurality of attributes of the first chess piece and that is the same as the first reinforcement attribute. For example, if the first reinforcement attribute is an attack force, the first attribute is an attack force of the chess piece. For example, the first attribute is an attribute that is in the plurality of attributes of the first chess piece and whose category is the same as a category of the first reinforcement attribute, and the category of the first reinforcement attribute may be a basic attribute or a functional attribute. For example, if the first reinforcement attribute is an attack force, and a category of the attack force is the basic attribute, the first attribute is an attribute that is in the plurality of attributes of the first chess piece and whose category is the basic attribute, for example, a health point, mana, an attack force, a spell power, an armor, magic resistance, an attack speed, and an attack distance.

After the first attribute is determined, the attribute that is of the first chess piece and that is in the reinforced state is determined based on the first attribute. In some embodiments, the attribute that is of the first chess piece and that is in the reinforced state may be understood as the attribute that is in the reinforced state and that is of the first chess piece. For example, an implementation of determining, based on the first attribute, the attribute that is of the first chess piece and that is in the reinforced state may be: using the first attribute as the attribute that is of the first chess piece and that is in the reinforced state. For example, the implementation of determining, based on the first attribute, the attribute that is of the first chess piece and that is in the reinforced state may alternatively be: determining, based on the first reinforcement attribute and the first attribute, the attribute that is of the first chess piece and that is in the reinforced state. For example, an attribute that is in the first attribute and that is the same as the first reinforcement attribute is used as the attribute that is of the first chess piece and that is in the reinforced state.

In the technical solution provided in this embodiment of this disclosure, different types of reinforcement cards are set. For example, the reinforcement card corresponds to one reinforcement attribute or the reinforcement card corresponds to a plurality of reinforcement attributes, and the first attribute of the chess piece is reinforced by using the first reinforcement attribute corresponding to the reinforcement card, to obtain the attribute that is of the chess piece and that is in the reinforced state. The user may properly select the reinforcement card or the first reinforcement attribute based on the game process to reinforce a capability of the chess piece, so that strategies for game arrangements may be enriched, interestingness of the game and game experience may be improved, and an interaction rate between the user and the game may be improved.

In an example embodiment of this disclosure, after the first chess piece and the first reinforcement attribute are determined, the reinforcement card may be used on the first chess piece, and the first chess piece is in the reinforced state. In this case, the first reinforcement identifier and the first count may be displayed in the first game turn interface. The first reinforcement identifier is configured to represent that the first chess piece is in the reinforced state, and the first count represents the remaining count of the reinforcement count, for example, the quantity of times that the reinforcement card may still be used. In some embodiments, that the first chess piece is in the reinforced state refers to that the attribute of the first chess piece is in the reinforced state.

In some embodiments, lasting duration of the reinforced state is less than or equal to duration of the first game turn. In some embodiments, the lasting duration may also be referred to as a lasting time length, and the duration of the first game turn may also be referred to as a time length of the first game turn. For example, the lasting duration of the reinforced state is equal to the duration of the first game turn. In this example, the first chess piece is in the reinforced state from the beginning to the end of the entire game turn. Alternatively, when the reinforcement cards are different, lasting time lengths of corresponding reinforced states are also different, and the lasting time length of the reinforced state may be less than the time length of the first game turn. After the first chess piece is in the reinforced state, timing starts. After the reinforced state of the first chess piece reaches a reinforcement time length corresponding to the reinforcement card, the first chess piece may be in an unreinforced state. In some embodiments, the reinforcement time length corresponding to the reinforcement card refers to the lasting time length of the reinforced state corresponding to the reinforcement card.

In some embodiments, when different types of reinforcement cards are used on the first chess piece, corresponding first reinforcement identifiers may also be different. For example, when the reinforcement card is configured to reinforce an attack force of the first chess piece, the first reinforcement identifier may be red; and when the reinforcement card is configured to reinforce a health point of the first chess piece, the first reinforcement identifier may be green. In this disclosure, an example in which colors of the first reinforcement identifiers are configured to distinguish between the reinforcement attributes is used for description, and different shapes may also be used for distinguishing between the reinforcement attributes corresponding to the first reinforcement identifiers. This is not limited in this disclosure. The user can clearly and intuitively learn the reinforcement attributes of the first chess piece by using different first reinforcement identifiers, so that the two parties have better arrangements to respond to game strategies, thereby improving competitiveness in the game process, and further improving a man-machine interaction rate.

For example, the first count and the first reinforcement identifier are displayed in a surrounding region of the first chess piece, to clearly exhibit that the first count and the first reinforcement identifier are information displayed after the first chess piece is reinforced by using the reinforcement card. The surrounding region of the first chess piece may include, but is not limited to, an upper region of the first chess piece, a lower region of the first chess piece, a left region of the first chess piece, a right region of the first chess piece, and the like. The first count and the first reinforcement identifier may be displayed in the surrounding region of the first chess piece and displayed on a same side, or may be displayed in the surrounding region of the first chess piece and displayed on different sides. For a case in which the first count and the first reinforcement identifier are displayed in the surrounding region of the first chess piece and displayed on the same side, the first count may be displayed in the first reinforcement identifier, or may be displayed independently outside the first reinforcement identifier.

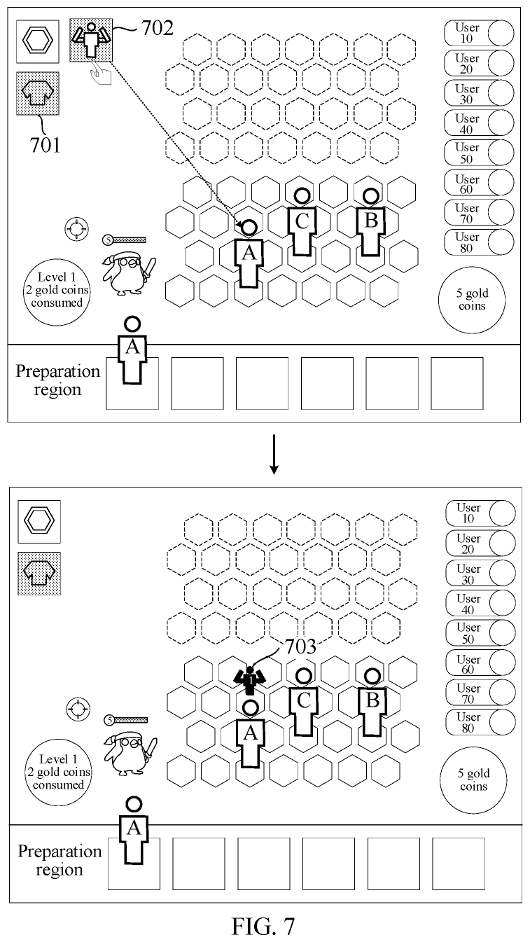

FIG. 7 is a schematic diagram of a first game turn interface including a reinforcement process of a first chess piece according to an embodiment of this disclosure. As shown in FIG. 7, a prop bar 701 may be displayed in the first game turn interface. After a user clicks/taps the prop bar 701, a reinforcement card 702 possessed by a virtual character may be displayed. The user may directly drag the reinforcement card 702 to a first chess piece located in a battle region, for example, a chess piece A located in the battle region, and the first chess piece is in a reinforced state. In this case, a first reinforcement identifier 703 may be displayed in a region around the first chess piece, and a first count may be displayed in the first reinforcement identifier 703. The first count may represent a quantity of times the reinforcement card 702 may still be used. For example, the current reinforcement card 702 may still be used once.

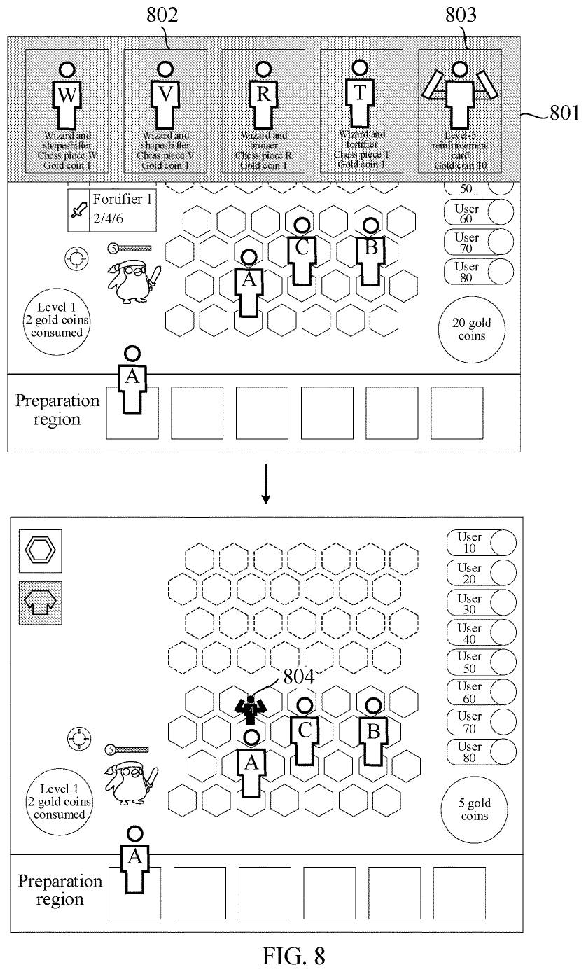

An example in which a reinforcement card in this disclosure is a multi-level reinforcement card is used for description. FIG. 8 is a schematic diagram of a process of a first game turn interface including a first reinforcement identifier and a first count according to an embodiment of this disclosure. As shown in FIG. 8, a card presentation region 801 may be displayed in a card obtaining interface in the first game turn, and the card presentation region 801 may include a chess piece card 802 and a reinforcement card 803. The reinforcement card 803 is a 5-level reinforcement card. For example, the current reinforcement card may be used for 5 times, and a chess piece is reinforced for 5 times. After obtaining the reinforcement card 803, a user may use the reinforcement card 803 on a first chess piece (a chess piece A) in the first game turn, a first reinforcement identifier 804 may be displayed around the first chess piece, and the first count may be displayed in the first reinforcement identifier 804.

Related content in FIG. 8 is similar to content in FIG. 5 and FIG. 7, so that reference may be made to related descriptions in FIG. 5 and FIG. 7, and details are not described herein again. In addition, the first count may be displayed in the first reinforcement identifier, or may be displayed independently outside the first reinforcement identifier. This is not limited in this disclosure.

In an example embodiment of this disclosure, after the first chess piece is reinforced, chess pieces of two parties may automatically battle, and when the first game turn meets an ending condition, a plurality of chess pieces and a reinforcement card of a second game turn are displayed; and when the first count is greater than a count threshold, an attribute of a second chess piece is reinforced in response to an operation of using the reinforcement card on the second chess piece, and a second count and a second reinforcement identifier are displayed. For example, the plurality of chess pieces and the reinforcement card may be displayed through a second game turn interface, and the second count and the second reinforcement identifier may be displayed in the second game turn interface, and the second game turn interface refers to an interface of the second game turn. In this case, when the first game turn meets the ending condition, the second game turn interface is displayed, and the second game turn interface includes the plurality of chess pieces and the reinforcement card; and when the first count is greater than the count threshold, and the operation of using the reinforcement card is performed on the second chess piece, the attribute of the second chess piece is reinforced, and the second count and the second reinforcement identifier are displayed in the second game turn interface, and the second reinforcement identifier is configured to represent that the attribute of the second chess piece is in the reinforced state, and the second count represents a remaining count of a reinforcement count, and the second chess piece is any one or more of the plurality of chess pieces.

For example, the ending condition of the first game turn may be that, in chess pieces of the two battle parties, when blood volumes of chess pieces of one party are 0, for example, when one of the two battle parties is defeated, the first game turn ends, and a system automatically matches another user for the winning party, and a battle of the second game turn is performed. In the second game turn, the second game turn interface including the plurality of chess pieces is displayed. For example, the second game turn may be one game turn after the first game turn, or may be a plurality of game turns after the first game turn. The second game turn interface is similar to the first game turn interface, so that reference may be made to the related descriptions of the first game turn interface in operation 201, and details are not described herein again.

After the second game turn interface is displayed, if a reinforcement count of a reinforcement card of a virtual object user, for example, the first count is greater than the count threshold, the reinforcement card may continue to be used for reinforcing the second chess piece in the second game turn. In the second game turn, the user may select the second chess piece to use the reinforcement card. The second chess piece may be the same as the first chess piece, for example, the reinforcement operation continues to be performed on the first chess piece in the second game turn; or the second chess piece may be different from the first chess piece, for example, in the second game turn, the user may select a new chess piece to perform the reinforcement operation; or the second chess piece may include the first chess piece, for example, in the second game turn, the user may continue to reinforce the first chess piece, and may also reinforce another new chess piece simultaneously. The user has relatively high flexibility in selecting a reinforced chess piece in the second game turn, which is conducive to improving game experience of the user, and further improving a man-machine interaction rate.

The count threshold may be set according to experience, or may be flexibly adjusted according to a requirement. This is not limited in this embodiment of this disclosure. For example, the count threshold may be set to 0. When the first count is greater than 0, for example, the reinforcement card may continue to be used in the second game turn, a use operation of the reinforcement card is detected, and the second reinforcement identifier and the second count may be displayed around the second chess piece in the second game turn interface. The second reinforcement identifier is configured to represent that the second chess piece is in the reinforced state. The second reinforcement identifier may be different from the first reinforcement identifier, or may be the same as the first reinforcement identifier.

For example, the second count may be displayed in the second reinforcement identifier, and the second count is less than the first count. The second count is a difference between the first count and a use count of the reinforcement card. The use count of the reinforcement card refers to a quantity of times that the reinforcement card used on the second chess piece. A process of reinforcing the second chess piece in the second game turn is similar to the process of reinforcing the first chess piece in the first game turn, so that reference may be made to the related descriptions above, and details are not described herein again.

In an example embodiment of this disclosure, with use of the reinforcement card, the reinforcement count is reduced accordingly. When the first count is not greater than the count threshold, second prompt information is displayed in response to the operation of using the reinforcement card on the second chess piece, and the second prompt information is configured to prompt that the attribute of the second chess piece is in an unreinforced state.

For example, the count threshold may be set to 0. When the first count is not greater than 0, in an example, the reinforcement card may not continue to be used in the second game turn, the use operation of the reinforcement card is detected, and the second prompt information may be displayed, and the second prompt information is configured to prompt that the reinforcement card may not be used, for example, the second prompt information is configured to prompt that the second chess piece is in the unreinforced state.

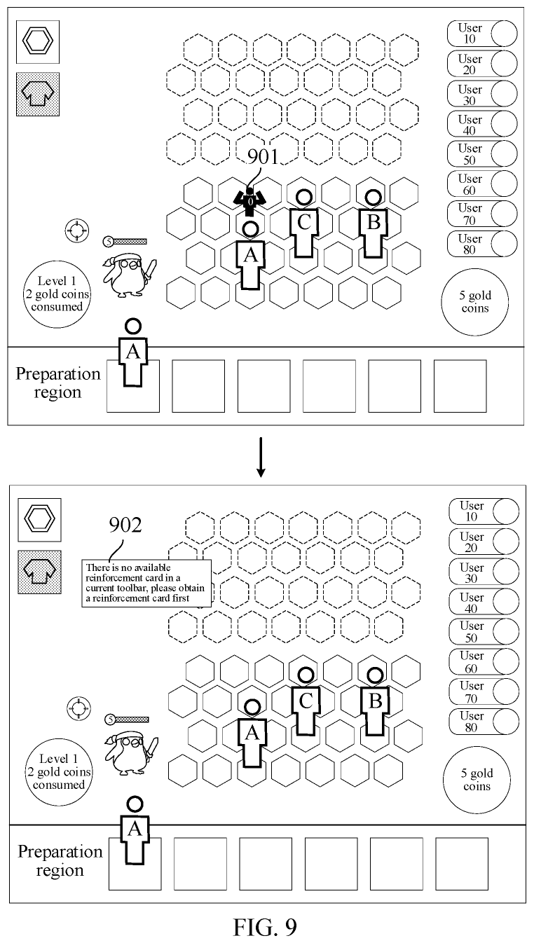

FIG. 9 is a schematic diagram of a process of a game turn interface including second prompt information according to an embodiment of this disclosure. As shown in FIG. 9, a first reinforcement identifier 901 may be displayed in a first game turn interface. A first count in the first reinforcement identifier 901 is 0, for example, a reinforcement card may not be used in a second game turn. In the second game turn, if a use operation of the reinforcement card is detected, second prompt information 902 may be displayed in a second game turn interface. For example, the second prompt information 902 is “There is no available reinforcement card in a current toolbar. Please first obtain the reinforcement card.”

In a technical solution provided in this embodiment of this disclosure, when a reinforcement count of the reinforcement card is not greater than a count threshold, for example, when the reinforcement card may not be used again, if it is detected that the reinforcement card is used again, the second prompt information is generated. The second prompt information may feed back a use status of the reinforcement card to a user in time, and guides the user to obtain a new reinforcement card, which can improve a man-machine interaction rate to some extent.

In an example embodiment of this disclosure, a process of reinforcing the chess piece by using the reinforcement card in the first game turn or the second game turn may include the following two embodiments.

Embodiment 1: A quantity of reinforcement cards is a first quantity, the first quantity of reinforcement cards are configured to reinforce a count of the first quantity of a target chess piece, and the target chess piece is one chess piece in a plurality of chess pieces. For example, reinforcing the count of the first quantity of the target chess piece may be understood as reinforcing the target chess piece for the count of the first quantity, or may be understood as performing the count of the first quantity of reinforcement on the target chess piece. For example, reinforcing the target chess piece refers to reinforcing an attribute of the target chess piece.

For example, in the first game turn, when a virtual character possesses a plurality of reinforcement cards, different reinforcement cards may be used on the same target chess piece. In this case, reinforcement effects of the plurality of reinforcement cards on the target chess piece may be superimposed. For example, the virtual character possesses three reinforcement cards, and the three reinforcement cards are respectively configured to reinforce an attack force, a defense power, and a health point of a chess piece. The user may use the three reinforcement cards separately on a chess piece A located in a preparation region, and an attack force, a defense power, and a health point of chess piece A may be respectively reinforced, so that reinforcement effects are superimposed.

Embodiment 2: A quantity of reinforcement cards is a second quantity, the second quantity of reinforcement cards are configured to reinforce a third quantity of target chess pieces, the third quantity of target chess pieces are chess pieces in the plurality of chess pieces, and the third quantity is less than or equal to the second quantity. In other words, the second quantity of reinforcement cards are configured to reinforce the third quantity of chess pieces in the plurality of chess pieces. For example, a third quantity of to-be-reinforced target chess pieces are selected from the plurality of chess pieces. The third quantity may be a quantity greater than 1. When the quantity of the reinforcement cards is plural, the target chess pieces may be reinforced, and a quantity of reinforced target chess pieces is less than or equal to the quantity of reinforcement cards possessed by the virtual character. For example, the virtual character possesses three reinforcement cards, which may be configured to reinforce target chess pieces, and a quantity of target chess pieces may be greater than 1 and less than or equal to 3. In other words, the three reinforcement cards may be configured to reinforce any two or three chess pieces of a chess piece A, a chess piece B, and a chess piece C in a battle region.

In the technical solution provided in this embodiment of this disclosure, in the first game turn or the second game turn, the plurality of reinforcement cards may be used on the same target chess piece, and the reinforcement effects corresponding to the reinforcement cards are superimposed, enabling the target chess piece to obtain a stronger attribute bonus, so that the user holds a greater advantage in the game; or the plurality of reinforcement cards may be used on different target chess pieces, which is conducive to improving an overall battle power of the chess pieces, so that chess pieces of a user party can maintain relatively high flexibility and adaptability in different cases.

In the technical solution provided in this embodiment of this disclosure, the chess piece selected by the user is reinforced by using the reinforcement card, so that the user can flexibly select the chess piece to be reinforced in the first game turn, thereby improving flexibility of the reinforcement process of the chess piece. The reinforcement process is based on a game turn, and the reinforced chess piece may be determined in different game turns, to prevent the reinforcement effect of the chess piece from acting on an entire round of the game, so that flexibility and instantaneity of the chess piece reinforcement in the entire round of the game may be improved, and game strategies of the user are enriched and interestingness in the game process is improved, thereby improving a man-machine interaction rate of the turn-based chess game. In addition, after the reinforcement card is used, the first reinforcement identifier may be displayed (for example, displayed in the first game turn interface), so that the user can intuitively learn the reinforced state of the chess piece. In addition, in the game process, a battle capability of the chess piece can be improved by reinforcing the chess piece, so that duration of game playing may be reduced to some extent, and efficiency of the game playing is improved, thereby saving computer resources.

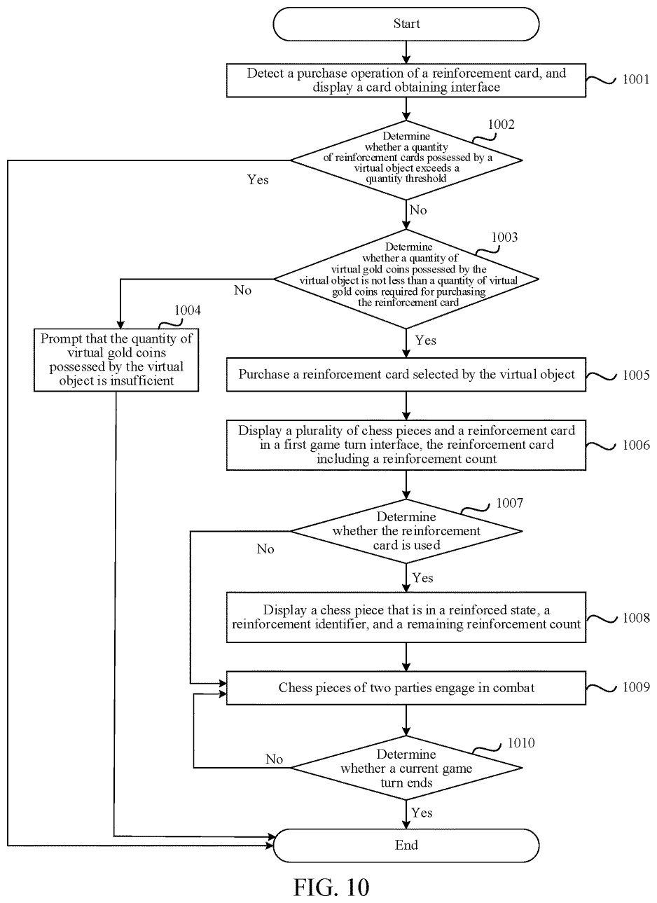

FIG. 10 is a flowchart of another chess piece reinforcement method for a turn-based chess game according to an embodiment of this disclosure. The method may be performed by a terminal (the first terminal and the second terminal) in the computer system shown in FIG. 1. The method includes the following content:
Operation 1001: Detect a purchase operation of a reinforcement card, and display a card obtaining interface.
Operation 1002: Determine whether a quantity of reinforcement cards possessed by a virtual object exceeds a quantity threshold. If the quantity of reinforcement cards possessed by the virtual object exceeds the quantity threshold, the procedure ends. If the quantity of reinforcement cards possessed by the virtual object does not exceed the quantity threshold, operation 1003 is performed.
Operation 1003: Determine whether a quantity of virtual gold coins possessed by the virtual object is not less than a quantity of virtual gold coins required for purchasing the reinforcement card. If the quantity of virtual gold coins possessed by the virtual object is less than the quantity of virtual gold coins required for purchasing the reinforcement card, operation 1004 is performed, and if the quantity of virtual gold coins possessed by the virtual object is not less than the quantity of virtual gold coins required for purchasing the reinforcement card, operation 1005 is performed.
Operation 1004: Prompt that the quantity of virtual gold coins possessed by the virtual object is insufficient.
Operation 1005: Purchase a reinforcement card selected by the virtual object.
Operation 1006: Display a plurality of chess pieces and a reinforcement card in a first game turn interface, where the reinforcement card includes a reinforcement count.
Operation 1007: Determine whether the reinforcement card is used, and if the reinforcement card is used, operation 1008 is performed, or if the reinforcement card is not used, operation 1009 is performed.
Operation 1008: Display a chess piece that is in a reinforced state, a reinforcement identifier, and a remaining reinforcement count.
Operation 1009: Chess pieces of two parties engage in combat.
Operation 1010: Determine whether a current game turn ends. If the current game turn ends, the procedure ends. If the current game turn does not end, operation 1009 is performed.

Operations in FIG. 10 are already described in operation 201 and operation 202, so that reference may be made to descriptions of related operations, and details are not described herein again.

In a technical solution provided in this embodiment of this disclosure, the chess piece selected by the user is reinforced by using the reinforcement card, so that the user can flexibly select the chess piece to be reinforced in the first game turn, thereby improving flexibility of a reinforcement process of the chess piece. The reinforcement process is based on a game turn, and the reinforced chess piece may be determined in different game turns, to prevent a reinforcement effect of the chess piece from acting on an entire round of the game, so that flexibility and instantaneity of the chess piece reinforcement in the entire round of the game may be improved, and game strategies of the user are enriched, thereby improving a man-machine interaction rate of the turn-based chess game. In addition, after the reinforcement card is used, the reinforcement identifier may be displayed (for example, displayed in the first game turn interface), so that the user can intuitively learn a reinforced state of the chess piece. In addition, in a game process, a battle capability of the chess piece can be improved by reinforcing the chess piece, so that duration of game playing may be reduced to some extent, and efficiency of the game playing is improved, thereby saving computer resources.

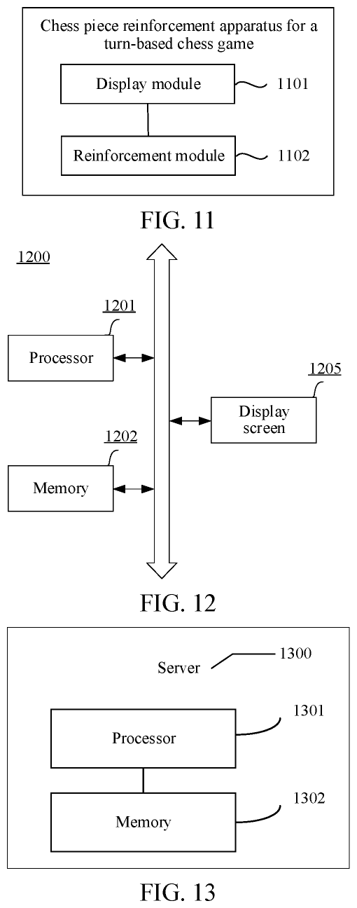

This disclosure further provides a chess piece reinforcement apparatus for a turn-based chess game. FIG. 11 is a schematic diagram of a structure of a chess piece reinforcement apparatus for a turn-based chess game according to an embodiment of this disclosure. As shown in FIG. 11, the apparatus includes:
a display module 1101, configured to display a plurality of chess pieces and a reinforcement card of a first game turn, the reinforcement card being configured to reinforce attributes of the chess pieces, and the reinforcement card including a reinforcement count; and
a reinforcement module 1102, configured to reinforce an attribute of a first chess piece in response to an operation of using the reinforcement card on the first chess piece, and display a first count and a first reinforcement identifier, the first reinforcement identifier being configured to represent that the attribute of the first chess piece is in a reinforced state, the first count representing a remaining count of the reinforcement count, and first chess piece being any one or more of the plurality of chess pieces.

In a possible implementation, the reinforcement card further includes a first reinforcement attribute, and the reinforcement module 1102 is further configured to determine a first attribute corresponding to the first reinforcement attribute from a plurality of attributes of the first chess piece; and determine, based on the first attribute, the attribute that is of the first chess piece and that is in the reinforced state.

In a possible implementation, the display module 1101 is further configured to display at least one reinforcement card in response to an obtaining operation of the reinforcement card; and
the apparatus further includes an allocation module (not shown in the figure), and the allocation module is configured to allocate the selected reinforcement card to the virtual character when the virtual character meets an obtaining condition of the reinforcement card, and the reinforcement card is selected, the virtual character being configured to control the plurality of chess pieces.

In a possible implementation, the display module 1101 is further configured to display a reinforcement prop, the reinforcement prop being associated with the selected reinforcement card; and display the selected reinforcement card in response to a trigger operation of the reinforcement prop.

In a possible implementation, the display module 1101 is further configured to display, when a refresh control is still displayed, a refreshed reinforcement card in response to a trigger operation of the refresh control.

In a possible implementation, the display module 1101 is further configured to display, when the refresh control is still displayed and a refresh count is not greater than a refresh count threshold, the refreshed reinforcement card in response to the trigger operation of the refresh control.

In a possible implementation, the display module 1101 is further configured to display, when a quantity of reinforcement cards already possessed by the virtual character is greater than or equal to a quantity threshold, first prompt information in response to the obtaining operation of the reinforcement card, the first prompt information being configured to guide a user to use the reinforcement card already possessed by the virtual character.

In a possible implementation, the display module 1101 is further configured to: display a plurality of chess pieces and a reinforcement card of a second game turn when the first game turn meets an ending condition; and
the reinforcement module 1102 is further configured to: reinforce, when the first count is greater than a count threshold, an attribute of a second chess piece in response to an operation of using the reinforcement card on the second chess piece, and display a second count and a second reinforcement identifier, the second reinforcement identifier being configured to represent that the attribute of the second chess piece is in a reinforced state, the second count representing a remaining count of the reinforcement count, and the second chess piece being any one or more of the plurality of chess pieces.

In a possible implementation, the display module 1101 is further configured to: display, when the first count is not greater than the count threshold, second prompt information in response to the operation of using the reinforcement card on the second chess piece, the second prompt information being configured to prompt that the attribute of second chess piece is in an unreinforced state.

In a possible implementation, the first chess piece is the same as the second chess piece; or the second chess piece is different from the first chess piece; or the second chess piece includes the first chess piece.

In a possible implementation, the reinforcement card further includes at least one of a reinforcement level, a reinforcement attribute effect, or a reinforcement virtual resource, where the reinforcement count is in positive correlation with at least one of the reinforcement level, the reinforcement attribute effect, or the reinforcement virtual resource, and the reinforcement virtual resource is a virtual resource required for obtaining the reinforcement card.

In a possible implementation, a quantity of reinforcement cards is a first quantity, the first quantity of reinforcement cards are configured to reinforce a target chess piece for a count of first quantity, and the target chess piece is one chess piece in the plurality of chess pieces.

In a possible implementation, the quantity of reinforcement cards is a second quantity, the second quantity of reinforcement cards are configured to reinforce a third quantity of chess pieces in the plurality of chess pieces, and the third quantity is less than or equal to the second quantity.

In a technical solution provided in this embodiment of this disclosure, the reinforcement module and the display module are used to reinforce the chess piece selected by the user by using the reinforcement card, so that the user can flexibly select the chess piece to be reinforced in the first game turn, thereby improving flexibility of the reinforcement process of the chess piece. The reinforcement process is based on a game turn, and the reinforced chess piece may be determined in different game turns, to prevent a reinforcement effect of the chess piece from acting on an entire round of the game, so that flexibility and instantaneity of the chess piece reinforcement in the entire round of the game may be improved, and game strategies of the user are enriched, thereby improving a man-machine interaction rate of the turn-based chess game. In addition, after the reinforcement card is used, the first reinforcement identifier may be displayed (for example, displayed in the first game turn interface), so that the user can intuitively learn the reinforced state of the chess piece. In addition, in a game process, a battle capability of the chess piece can be improved by reinforcing the chess piece, so that duration of game playing may be reduced to some extent, and efficiency of the game playing is improved, thereby saving computer resources.

When the apparatus provided above implements the functions of the apparatus, only division of the foregoing function modules is used as an example for description. In practical application, the foregoing functions may be allocated to and completed by different function modules according to requirements. In other words, an internal structure of the device is divided into different function modules, to complete all or some of the functions described above. In addition, the apparatus and method embodiments provided in the foregoing embodiments belong to the same conception. For a specific implementation process, refer to the method embodiments. Details are not described herein again.

FIG. 12 is a block diagram of a structure of a terminal device according to an embodiment of this disclosure. A terminal device 1200 may be any electronic device product that can perform man-machine interaction with a user in one or more manners such as a keyboard, a touchpad, a remote control, voice interaction, or a handwriting device, for example, a personal computer (PC), a mobile phone, a smartphone, a personal digital assistant (PDA), a wearable device, a pocket PC (PPC), a tablet computer, a smart infotainment, a smart television, a smart speaker, and a smartwatch.

In some embodiments, the terminal device 1200 includes a processor 1201 and a memory 1202.

The processor 1201 may include one or more processing cores, for example, a 4-core processor and an 8-core processor. The processor 1201 may be implemented in at least one hardware form of a digital signal processing (DSP), a field-programmable gate array (FPGA), or a programmable logic array (PLA). The processor 1201 may also include a main processor and a coprocessor. The main processor is a processor configured to process data in an active state, and is also referred to as a central processing unit (CPU). The coprocessor is a low-power consumption processor configured to process data in a standby state. In some embodiments, the processor 1201 may have a graphics processing unit (GPU) integrated therein. The GPU is configured to render and draw content that needs to be displayed on a display screen. In some embodiments, the processor 1201 may further include an artificial intelligence (AI) processor. The AI processor is configured to process computing operations related to machine learning.

The memory 1202 may include one or more computer-readable storage medium. The computer-readable storage medium may be non-transitory. The memory 1202 may also include a high-speed random access memory and a non-volatile memory, for example, one or more disk storage devices and flash storage devices. In some embodiments, the non-transitory computer-readable storage medium in the memory 1202 is configured to store at least one instruction. The at least one instruction is configured to be executed by the processor 1201 to perform the chess piece reinforcement method for the turn-based chess game provided in the method embodiments of this disclosure. In some embodiments, the non-transitory computer-readable storage medium may also be referred to as a non-volatile computer-readable storage medium.

In some embodiments, the terminal device 1200 may also include: a display screen 1205.

The display screen 1205 is configured to display a user interface (UI). The UI may include a graph, a text, an icon, a video, or any combination thereof. When the display screen 1205 is a touch display screen, the display screen 1205 further has a capability of capturing a touch signal on or above a surface of the display screen 1205. The touch signal may be input to the processor 1201 as a control signal for processing. In this case, the display screen 1205 may be further configured to provide a virtual button and/or a virtual keyboard, which are/is also referred to as a soft button and/or a soft keyboard. In some embodiments, there may be one display screen 1205, disposed on a front panel of the terminal device 1200. In some other embodiments, there may be at least two display screens 1205, disposed on different surfaces of the terminal device 1200 respectively or in a folded design. In some other embodiments, the display screen 1205 may be a flexible display, disposed on a curved surface or a folded surface of the terminal device 1200. The display screen 1205 may further be disposed in a non-rectangular irregular pattern, for example, a special-shaped screen. The display screen 1205 may be made of a liquid crystal display (LCD), an organic light-emitting diode (OLED), or other materials. In some embodiments, the chess pieces, the reinforcement card, controls and the like involved in the method embodiments of this disclosure are displayed through the display screen 1205.

A person skilled in the art may understand that the structure shown in FIG. 12 constitutes no limitation on the terminal device 1200, and the terminal device may include more or fewer components than those shown in the figure, or a combination of some components, or have a different arrangement of components.

FIG. 13 is a schematic diagram of a structure of a server according to an embodiment of this disclosure. A server 1300 may vary a lot due to different configurations or performance, and may include one or more processors 1301 and one or more memories 1302. The one or more memories 1302 store at least one piece of program code, and the at least one piece of program code is loaded and executed by the one or more processors 1301 to implement the chess piece reinforcement method for the turn-based chess game provided in the foregoing method embodiments. The server 1300 may further have assemblies such as a wired or wireless network interface, a keyboard, and an I/O interface for inputting and outputting. The server 1300 may further include other assemblies configured to implement device functions, and details are not described herein.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In an example embodiment, a non-transitory computer-readable storage medium is further provided, and the non-transitory computer-readable storage medium has at least one piece of program code stored therein. The at least one piece of program code is loaded and executed by a processor, to cause a computer to implement any one of the foregoing chess piece reinforcement methods for the turn-based chess game.

In some embodiments, the foregoing non-volatile computer-readable storage medium may be a read-only memory (ROM), a random access memory (RAM), a compact disc read-only memory (CD-ROM), a magnetic tape, a floppy disk, an optical data storage device, or the like.

In an example embodiment, a computer program or a computer program product is further provided. The computer program or the computer program product stores at least one computer instruction, and the at least one computer instruction is loaded and executed by a processor, to cause a computer to implement any one of the foregoing the chess piece reinforcement methods for the turn-based chess game.

“A plurality of” mentioned in this specification means two or more. And/or describes an association relationship for describing associated objects and represents that three relationships may exist. For example, A and/or B may represent the following three cases: Only A exists, both A and B exist, and only B exists. A character “/” generally represents an “or” relationship between the associated objects.

The foregoing descriptions are merely example embodiments of this disclosure, but are not intended to limit this disclosure. Any modification, equivalent replacement, or improvement made within the principle of this disclosure shall fall within the scope of this disclosure.

What is claimed is:

1. A chess piece reinforcement method for a turn-based chess game, the method comprising:
displaying a plurality of chess pieces and a reinforcement card on a first game turn, the reinforcement card being configured to reinforce at least one attribute of the chess pieces and is associated with a reinforcement count;
reinforcing an attribute of a first chess piece of the plurality of chess pieces based on use of the reinforcement card with the first chess piece; and
displaying a first count and a first reinforcement identifier, the first reinforcement identifier representing that the attribute of the first chess piece is in a reinforced state, and the first count representing a remaining count of the reinforcement count.

2. The method according to claim 1, wherein the reinforcement card further comprises a first reinforcement attribute, and the method further comprises:
determining a first attribute corresponding to the first reinforcement attribute from a plurality of attributes of the first chess piece; and
determining, based on the first attribute, the attribute of the first chess piece that is in the reinforced state.

3. The method according to claim 1, wherein the method further comprises:
displaying at least one reinforcement card based on an obtaining operation associated with the reinforcement card; and
allocating a selected reinforcement card to a virtual character when the virtual character meets an obtaining condition of the reinforcement card and the reinforcement card is selected, the virtual character controlling the plurality of chess pieces.

4. The method according to claim 3, wherein the method further comprises:
displaying a reinforcement prop associated with the selected reinforcement card; and
displaying the selected reinforcement card based on a trigger of the reinforcement prop.

5. The method according to claim 3, wherein the method further comprises:
displaying, when a refresh control element is displayed, a refreshed reinforcement card based on a trigger of the refresh control element.

6. The method according to claim 3, wherein the method further comprises:
displaying, when a refresh control element is displayed and a refresh count is not greater than a refresh count threshold, a refreshed reinforcement card based on a trigger of the refresh control element.

7. The method according to claim 3, wherein the method further comprises:
displaying, when a quantity of reinforcement cards already possessed by the virtual character is greater than or equal to a quantity threshold, first information based on the obtaining operation associated with the reinforcement card, the first information guiding a user to use the reinforcement card already possessed by the virtual character.

8. The method according to claim 1, wherein the method further comprises:
displaying a plurality of chess pieces and a second reinforcement card on a second game turn when the first game turn meets an ending condition;
reinforcing, when the first count is greater than a count threshold, an attribute of a second chess piece based on use of the reinforcement card with the second chess piece; and
displaying a second count and a second reinforcement identifier, the second reinforcement identifier representing that the attribute of the second chess piece is in a reinforced state, the second count representing a remaining count of the reinforcement count, and the second chess piece being at least one of the plurality of chess pieces.

9. The method according to claim 8, wherein the method further comprises:
displaying, when the first count is not greater than the count threshold, second information based on use of the reinforcement card with the second chess piece, the second information indicating that the attribute of the second chess piece is in an unreinforced state.

10. The method according to claim 8, wherein the second chess piece is the first chess piece, the second chess piece is different from the first chess piece, or the second chess piece comprises the first chess piece.

11. The method according to claim 1, wherein the reinforcement card further comprises at least one of a reinforcement level, a reinforcement attribute effect, or a reinforcement virtual resource, wherein the reinforcement count is in positive correlation with at least one of the reinforcement level, the reinforcement attribute effect, or the reinforcement virtual resource, and the reinforcement virtual resource includes a virtual resource required for obtaining the reinforcement card.

12. The method according to claim 7, wherein the quantity of reinforcement cards is a first quantity, the first quantity of reinforcement cards reinforce a target chess piece for a count of the first quantity, and the target chess piece is one chess piece in the plurality of chess pieces.

13. The method according to claim 7, wherein the quantity of reinforcement cards is a second quantity, the second quantity of reinforcement cards reinforce a third quantity of chess pieces in the plurality of chess pieces, and the third quantity is less than or equal to the second quantity.

14. A chess piece reinforcement apparatus for a turn-based chess game, the apparatus comprising:
processing circuitry configured to:
display a plurality of chess pieces and a reinforcement card on a first game turn, the reinforcement card being configured to reinforce at least one attribute of the chess pieces and is associated with a reinforcement count;
reinforce an attribute of a first chess piece of the plurality of chess pieces based on use of the reinforcement card with the first chess piece; and
display a first count and a first reinforcement identifier, the first reinforcement identifier representing that the attribute of the first chess piece is in a reinforced state, and the first count representing a remaining count of the reinforcement count.

15. The chess piece reinforcement apparatus according to claim 14, wherein the reinforcement card further comprises a first reinforcement attribute, and the processing circuitry is configured to:
determine a first attribute corresponding to the first reinforcement attribute from a plurality of attributes of the first chess piece; and
determine, based on the first attribute, the attribute of the first chess piece that is in the reinforced state.

16. The chess piece reinforcement apparatus according to claim 14, wherein the processing circuitry is configured to:
display at least one reinforcement card based on an obtaining operation associated with the reinforcement card; and
allocate a selected reinforcement card to a virtual character when the virtual character meets an obtaining condition of the reinforcement card and the reinforcement card is selected, the virtual character controlling the plurality of chess pieces.

17. The chess piece reinforcement apparatus according to claim 16, wherein the processing circuitry is configured to:
display a reinforcement prop associated with the selected reinforcement card; and
display the selected reinforcement card based on a trigger of the reinforcement prop.

18. The chess piece reinforcement apparatus according to claim 16, wherein the processing circuitry is configured to:
display, when a refresh control element is still displayed, a refreshed reinforcement card based on a trigger of the refresh control element.

19. The chess piece reinforcement apparatus according to claim 16, wherein the processing circuitry is configured to:
display, when a refresh control element is displayed and a refresh count is not greater than a refresh count threshold, a refreshed reinforcement card based on a trigger of the refresh control element.

20. A non-transitory computer-readable storage medium storing instructions which when executed by a processor cause the processor to perform:
displaying a plurality of chess pieces and a reinforcement card on a first game turn, the reinforcement card being configured to reinforce at least one attribute of the chess pieces and is associated with a reinforcement count;
reinforcing an attribute of a first chess piece of the plurality of chess pieces based on use of the reinforcement card with the first chess piece; and
displaying a first count and a first reinforcement identifier, the first reinforcement identifier representing that the attribute of the first chess piece is in a reinforced state, and the first count representing a remaining count of the reinforcement count.
